(19) United States
(12) Patent Application Publication
(10) Pub. No.: US 2004/0228043 A1
(43) Pub. Date: Nov. 18, 2004

(54) Miniature Magnetoresistive Multitap Sensor

(76) Inventors: Alexander Tesler, Palo Alto, CA (US); Dmitri Varsanofiev, San Diego, CA (US)

Correspondence Address: ALEXANDER TESLER, 3731 MIDDLEFIELD ROAD, PALO ALTO, CA, 94303-4715, US

(21) Appl. No.: 10/709,583

(22) Filed: May 15, 2004

Related U.S. Application Data
(60) Provisional application No. 60/471,091, filed on May 16, 2003.

(51) Int. Cl. G11B 5/127

(52) U.S. Cl. 360/324; 360/324.2

(57) ABSTRACT

A small-size magnetoresistive device which allows measurement of spatial distribution of magnetic field along one axis with high resolution is disclosed. The magnetoresistive device includes: a magnetoresistive stripe oriented along the measurement axis; a plurality of conductive layers comprising electrodes distributed along the length of the stripe, separated by insulating layers. The measurement of the spatial distribution of the magnetic field is performed by analyzing signal levels between electrodes.

### BACKGROUND OF INVENTION

The present invention in general relates to a novel device for magnetic microscopy. More specifically, the present invention relates to such a device using magnetoresistive materials.

With the continuously increasing recording density in magnetic storage media and the continual improvement in quality of magnetic heads in recent years it has become ever more important to be able to measure the spatial distribution of a magnetic field as accurately as possible, since this distribution in the vicinity of the gap in a magnetic head represents a factor which has a profound influence on the recording, overwrite and playback properties.

Magnetic writing and recording heads are therefore a field of intense research and development that requires extremely sensitive techniques to estimate device parameters for further miniaturization. In addition, it is desirable for process control that scientific and technical feedback for manufacturing parameters are enabled as early as possible in the production process, in particular on a row or slider level. Since production demands rapid measurement of the effective track width, the spatial distribution of the magnetic field across the track (along the gap) shall be performed quickly.

Techniques to image magnetic properties are based on electron microscopy such as spin polarized scanning electron microscopy (cf. R. Allenspach, Physics World, 7, 45 (1994)), Lorentz microscopy (cf. X. Portier et al., Appl. Phys. Lett., 71, 22032 (1997)), Magnetic Force Microscopy (cf. Y. Martin and H. K. Wickramasinghe, Appl. Phys. Lett. 50, 1455 (1987)), Spin Polarized Electron Tunneling Microscope (cf. Z. Wu et al., Surface Science, 386, 311 (1997)) Scanning Near Field Magnetooptical Microscopy (cf. U. Hartmann, Journal of Magnetism and Magnetic Materials, 157/158, 545 (1996)) and Kerr microscopy (A. Hubert and R. Schafer, Magnetic Domains, The Analysis of Magnetic Microstructures, New York 1998). A technique using layers of magnetosensitive materials on the surface of the object and measuring displacement using Scanning Force Microscope (U.S. Pat. No. 6,448,766).

The scanning methods in the prior art require two-dimensional mechanical scanning of the object under test and therefore consume significant time. The non-scanning optical methods of the prior art are limited in resolution by the wavelength of the light source used.

It is therefore an object of the present invention to provide a device to characterize magnetic fields and magnetic properties of microstructures that works faster than the scanning techniques of the prior art and is not as severely limited in resolution as the optical techniques of the prior art.

It is a further object of the invention to characterize such magnetic fields emanating from micrometer-sized devices, especially from magnetic read/write heads (RWH) used in storage technology.

It is still a further object of the present invention to characterize spatial distribution of the magnetic field along one axis without mechanical repositioning of the device.

Further advantageous embodiments of the invention are contained in the dependent claims

### SUMMARY OF INVENTION

The present invention presents a novel technique to characterize magnetic fields emanating from sub-micrometer-sized devices by using a magnetoresistive (MR) stripe with multiple electrodes distributed along the stripe.

For the first time, closely spaced electrodes are attached to the magnetoresistive stripe using techniques of semi-conductor manufacturing to probe the variation of a magnetic field in a microstructure.

It has to be mentioned that the subject-matter of the present invention is not restricted to Read/Write Heads but can in principle be applied to all objects, materials, samples and devices generating a magnetic field.

It also has to be mentioned that the basic principle of the construction of invented device is not limited by the magnetoresistive sensor but can be used in creating other types of sensors used for characterization of one-dimensional spatial distribution of other types of fields.

### BRIEF DESCRIPTION OF DRAWINGS

FIG. 1 shows conceptual construction of the device according to the invention,

FIG. 2A depicts sectional view of alternating metal and dielectric layers on the semiconductor substrate

FIG. 2B illustrates cut across said layers.

FIG. 2C shows magnetoresistive stripe formed on the surface of the said cut.

FIG. 2D illustrates the usage of the device build as illustrated in FIGS. 2(A to C).

FIG. 3A depicts sectional view of alternating metal and dielectric layers on the semiconductor substrate

FIG. 3B illustrates channel etched in said layers.

FIG. 3C shows magnetoresistive stripe formed on the walls of the said channel.

FIG. 3D illustrates cut along said channel.

FIG. 3E shows plain view of the said cut

FIG. 3F illustrates the cut across the said channel

FIG. 3G illustrates the usage of the device build as illustrated in FIGS. 3(A to F).

### DETAILED DESCRIPTION

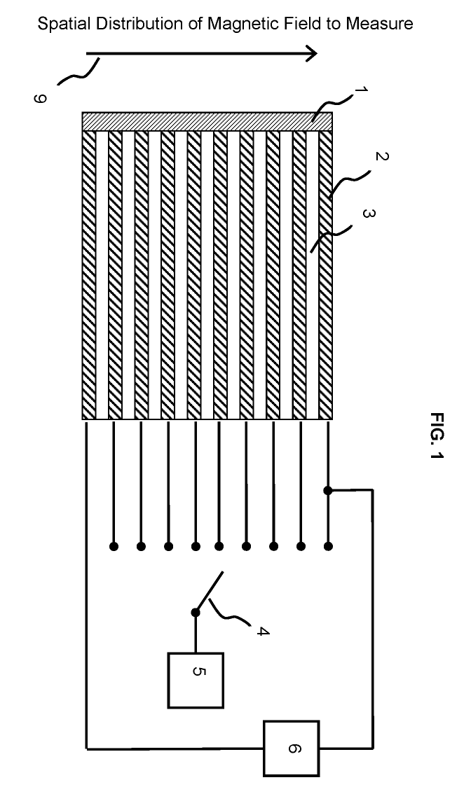

FIG. 1 is a sectional view showing construction of a miniature magnetoresistive multitap sensor device according to the present invention. As shown therein, a magnetoresistive strip 1, oriented along the measurement axis 9, and connected to conductive layers electrodes 2, separated by insulating layers 3. Top and bottom conducting layers are connected to the bias current supply 6. Each electrode is connected to the voltage measuring device comprised of electrical switch 4 and voltmeter 5.

Presence of a spatially distributed magnetic field causes corresponding changes of spatial distribution of an electrical resistance along magnetoresistive strip. Presence of a bias current causes voltage distribution along said strip in direct correlation with electrical resistance distribution, and, therefore, voltage distribution at the tapping electrodes. Measurement of the said voltage distribution using a voltage measuring device allows for calculation of the spatial distribution of the said magnetic field.

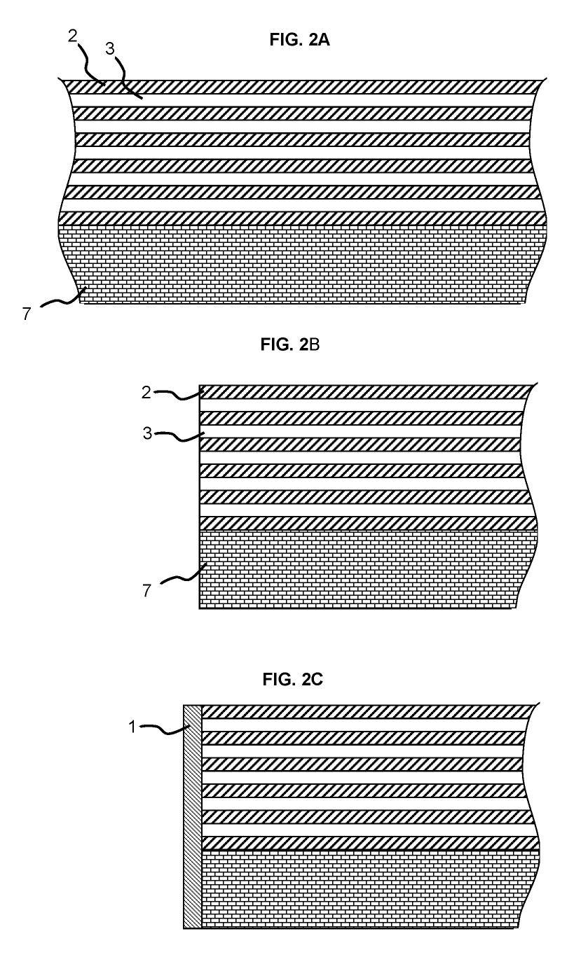

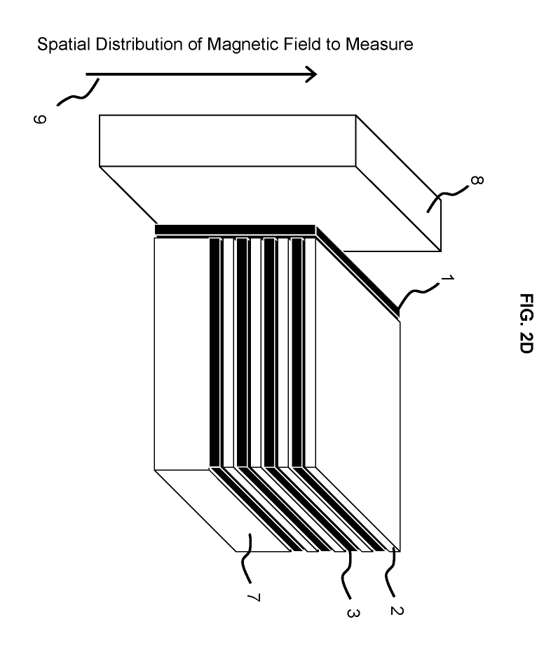

FIGS. 2A, 2B and 2C illustrate the process of creation of a miniature magnetoresistive multitap sensor device according to the present invention. At the beginning, alternating layers of metal 2 and dielectric 3 are formed on top of semiconductor substrate 7 as shown on FIG. 2A. Thus formed “layered sandwich” is cut and polished across the layers as shown on FIG. 2B. Then a magnetoresistive strip deposited on the surface produced by the said cut as shown on FIG. 2C. Additional protective layers (not shown on the drawing) can be deposited on top of magnetoresistive layer. Measurement using the created device are illustrated on FIG. 2D. Object under test 8 are positioned in front of a magnetoresistive strip surface the way that spatial magnetic field distribution of interest is distributed across conductive layers of said device.

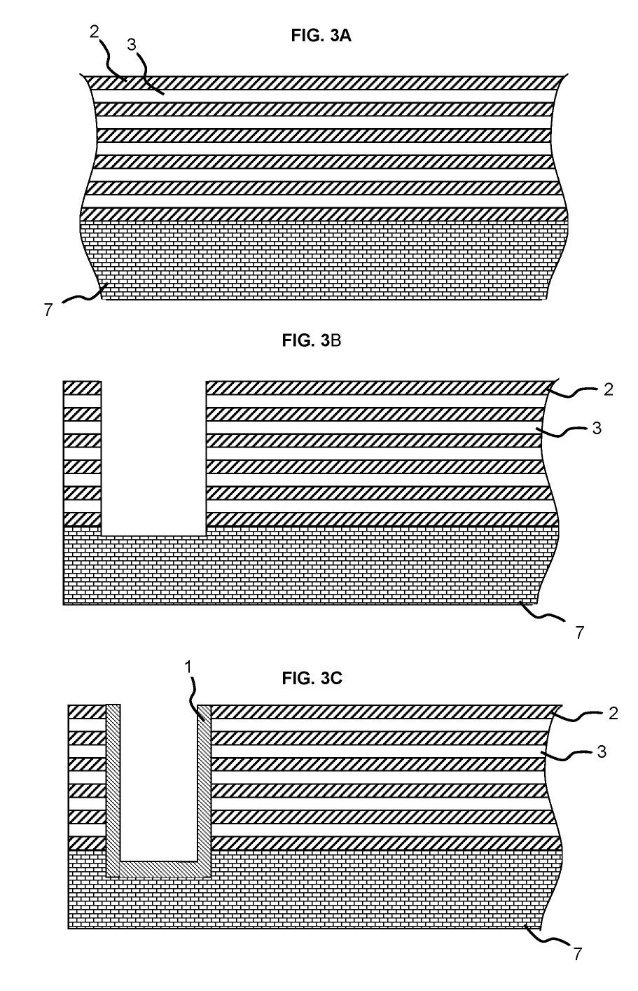

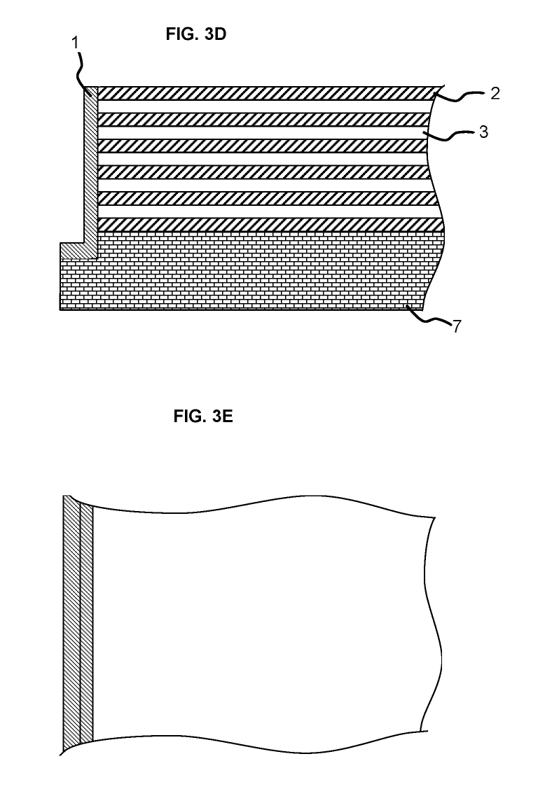

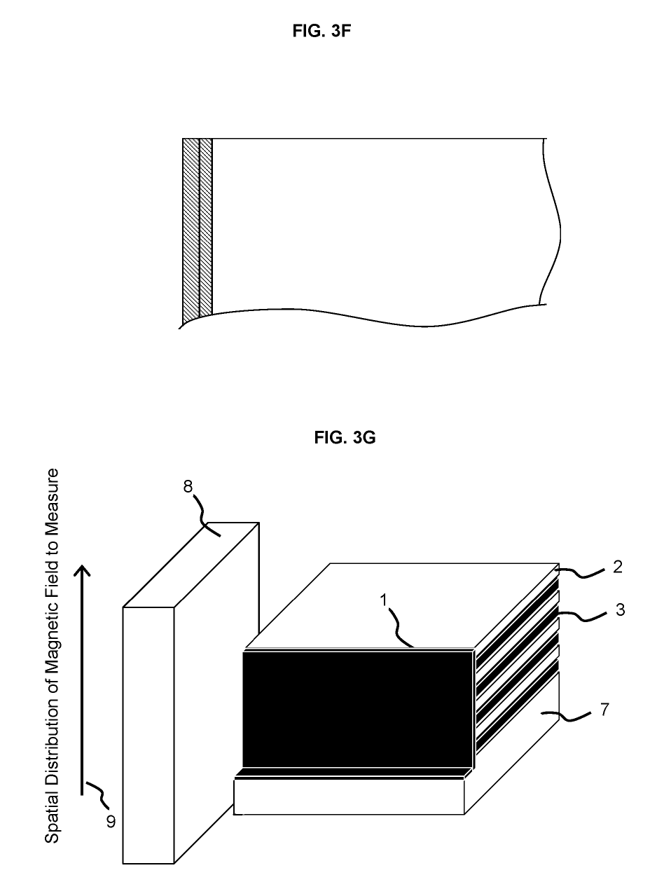

FIGS. 3A, 3B, 3C, 3D, 3E and 3F illustrate alternative process of creation of a miniature magnetoresistive multitap sensor device according to the present invention. At the beginning, the alternating layers of metal 2 and dielectric 3 are formed on top of semiconductor substrate 7 as shown on FIG. 3A. Then a channel etched in the said layers as shown on FIG. 3B. Then a magnetoresistive layer(s) 1 is deposited on the walls of said channel as shown on FIG. 3C. Additional protective and shielding layers (not shown on the drawing) can be deposited on top of magnetoresistive layer.

Resulting wafer is cut along the channel as shown on FIGS. 3D and 3E in sectional and plain view. Resulting strips are cut and polished across the channel as shown on FIG. 3F.

Measurement technique using the invented device is illustrated on FIG. 3G. Object under test 8 is positioned in front of a magnetoresistive strip edge so that the spatial magnetic field distribution of interest is distributed along the edge of a magnetoresistive strip and across the conductive layers of the said device.

1. A small-size magnetoresistive device which allows measurement of spatial distribution of magnetic field along one axis with high resolution that includes:
a magnetoresistive stripe oriented along the measurement axis,
a plurality of conductive layers comprising electrodes distributed along the length of the stripe, separated by insulating layers.

2. A small-size magnetoresistive device according to claim 1, wherein the said conductive layers are formed as thin metal layers on the semiconductor substrate or insulation layers, and said insulation layers are thin dielectric layers formed on the said conductive layers or the said semiconductor substrate, and the said magnetoresistive stripe is formed on the surface produced by a cut across said metal and dielectric layers.

3. A small-size magnetoresistive device according to claim 1, wherein the said conductive layers are formed as thin metal layers on the semiconductor substrate or insulation layers, and said insulation layers are thin dielectric layers formed on the said conductive layers or the said semiconductor substrate, and the said magnetoresistive stripe is formed on the wall of the channel produced by etching of the said metal and dielectric layers.
